(19) United States
(12) Patent Application Publication
(10) Pub. No.: US 2013/0204682 A1
(43) Pub. Date: Aug. 8, 2013

(54) SYSTEM AND METHOD FOR REDUCING CHURN FOR A COMMUNICATIONS SERVICE

(71) Applicant: Mark Stachiw, Parker, TX (US)

(72) Inventor: Mark Stachiw, Parker, TX (US)

(73) Assignee: Metro PCS Wireless, Inc.

(21) Appl. No.: 13/413,429

(22) Filed: Mar. 6, 2012

Related U.S. Application Data
(60) Provisional application No. 61/594,876, filed on Feb. 3, 2012.

(51) Int. Cl. G06Q 30/02

(52) U.S. Cl. 705/14.14

(57) ABSTRACT

A method and system of reducing churn of customers for a communications service provider may include storing account information of a customer of the communications service provider. The customer account information may include customer service plan data and customer history data. The customer account information may be accessed by a computing unit. A total number of points collected by the customer during a time period based on the customer account information may be determined. The calculation may include totaling points associated with the customer service plan data and customer history data. A number of sweepstakes entries the customer achieved based on the calculated total number of points may be determined. The customer may be entered into the sweepstakes with one or more achieved sweepstakes entries for the time period. A sweepstakes drawing for the sweepstakes may be conducted, and a prize may be awarded to a winner of the sweepstakes.

### RELATED APPLICATIONS

This application claims the benefit, under 35 USC §119(e), of the filing of co-pending U.S. Provisional Patent Application Ser. No. 61/594,876, entitled “SYSTEM AND METHOD FOR REDUCING CHURN FOR A COMMUNICATIONS SERVICE” filed Feb. 3, 2012, which is incorporated herein by reference in its entirety.

### BACKGROUND

Communications services and communications providers may generally be categorized in two groups, post-paid and pre-paid. Post-paid services and providers generally rely upon accurate customer information, credit checks, and payment histories to determine a customer's ability to pay. Post-paid customers receive a bill, usually on a periodic basis (e.g., monthly) for services provided to the customer by the service provider or a third party after the service has been rendered. Post-paid communications services usually require long term commitments by the customer, frequently an annual-basis contract.

Prepaid services and providers come in many different flavors. However, the various flavors of prepaid services and providers share a common theme that customers pay for their service in advance. Customers might pre-pay for a metered service (e.g., a certain number of minutes, text messages, or kilobytes of data). Alternatively, a customer might pre-pay or pay in advance on a generally flat-rate basis for an unlimited service. Pre-paid services and providers have less stringent credit checks, if any, since their customers have already paid for their services, whatever those services might be. Pre-paid providers are able to save on credit checks and bill collection fees that post-paid providers must include in their costs.

Moreover, prepaid and/or flat-rate communications service providers operate with no long term or annual commitments or contracts with customers. As a result of flat-rate communications service providers generally not having long term commitments, customers tend to change service providers more frequently. Customers who leave communications services entirely or change service providers is commonly known as “churn” in the communications industry. While churn is a problem for all communications service providers, churn tends to be a more substantial problem for no annual contract, flat-rate communications service providers because such service plans tend to attract more value oriented, money conscious customers who are more likely to cancel their service when financial challenges arise. As a result, no annual contract, flat-rate communications service providers have historically had higher churn rates than non-flat-rate, post-pay communications service providers that have long-term commitments (e.g., 2-year contracts).

Communications service providers that offer prepaid or no annual contract, flat-rate communications service plans do not perform background or credit checks, so some of these communications service providers do not verify names or addresses of their customers. Customers with prepaid or no annual contract, flat-rate, prepaid plans who have home locations outside of areas that are serviced by a communications service provider have significantly higher cost for the communications service provider due to these customers primarily operating in roaming areas that the communications service provider has to pay for out of the flat-rate fees.

Prepaid and no annual contract customers also have a high incidence of not paying on time or when the customers still have money remaining in their account. This causes the communications service provider to have less certainty of revenue since it is not sure when the revenue will be paid, if at all.

### SUMMARY

In an effort to reduce customers cancelling their communications services, such as fixed-rate communications services, the principles of the present invention provide for a sweepstakes or similar incentive program for customers of no annual contract or prepaid, fixed-rate communications services. The sweepstakes incentive program enables customers to accumulate points over a time period for entries into the sweepstakes. The points may be collected by the customers in a variety of ways, including having particular service plans, performing certain actions, using certain communications devices, and so on. As a result of the customers collecting points and having an opportunity to win sweepstakes, churn of the customers for the communications service provider may be reduced. The principles of the present invention also provide incentives for customers to pay early or to pay while they still have money remaining in their account since the sweepstakes can limit participation to customers who have paid on time (or removal of customers who have not paid on time).

One embodiment of a method and system of reducing churn for a communications service provider may include storing, by a data repository, account information of a customer of the communications service provider. The customer account information may include customer service plan and device data and customer history data. The customer account information may be accessed by a computing unit. The computing unit may calculate a total number of points collected by the customer during a time period based on the customer account information. In one embodiment, the calculation may include totaling points associated with the customer service plan data and customer history data. A number of sweepstakes entries the customer achieved based on the calculated total number of points may be determined. The customer may be entered into the sweepstakes with at least a portion of the achieved sweepstakes entries for the time period. A sweepstakes drawing for the sweepstakes may be conducted, and a prize may be awarded to a winner of the sweepstakes.

### BRIEF DESCRIPTION

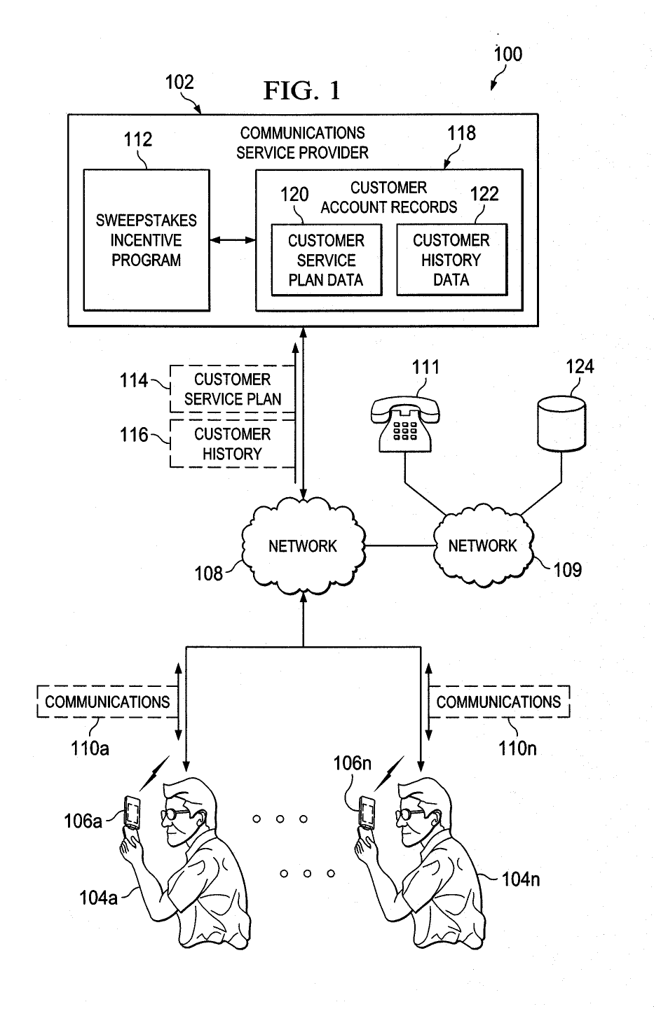

FIG. 1 is an illustration of an illustrative telecommunications service provider that offers a sweepstakes incentive program to its customers;

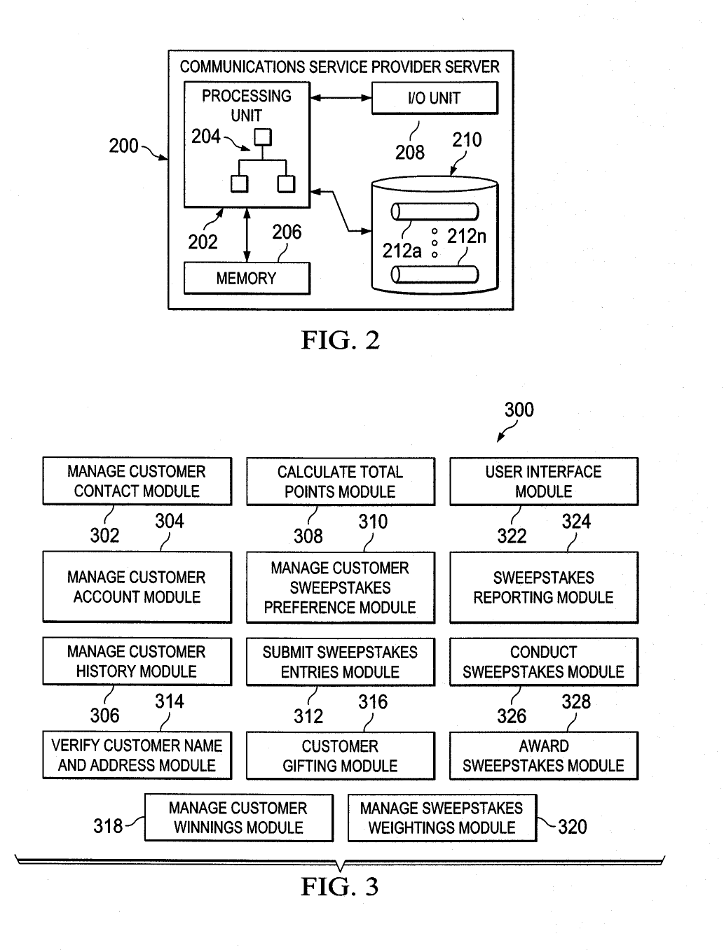

FIG. 2 is a block diagram of an illustrative computing system that is configured to operate the sweepstakes incentive program for a communications service provider;

FIG. 3 is a block diagram of illustrative software modules that may be utilized to operate the sweepstakes incentive program;

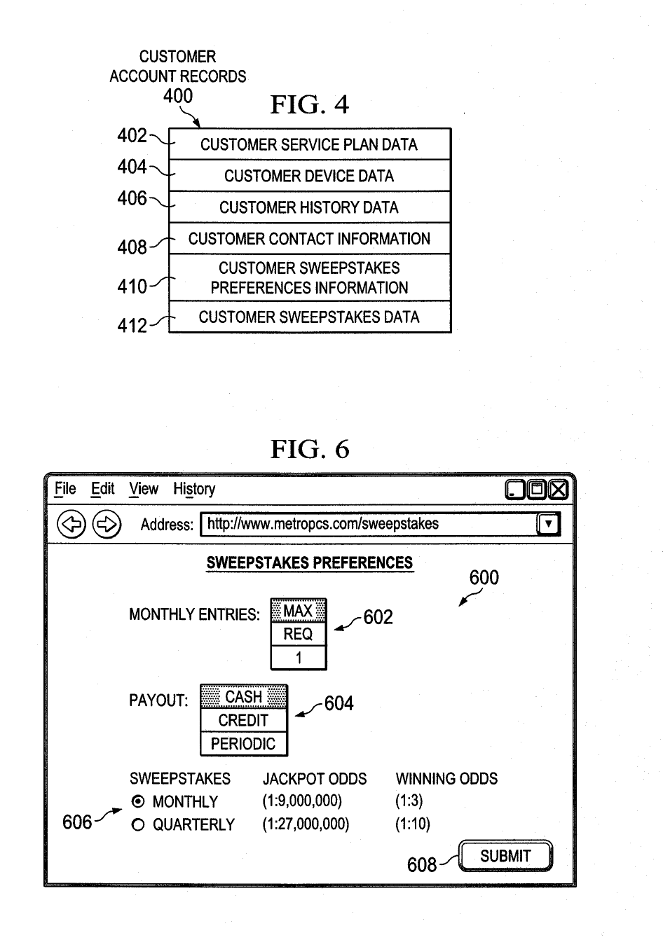

FIG. 4 is a table of illustrative customer account records that, in part, may be utilized in supporting the sweepstakes incentive program;

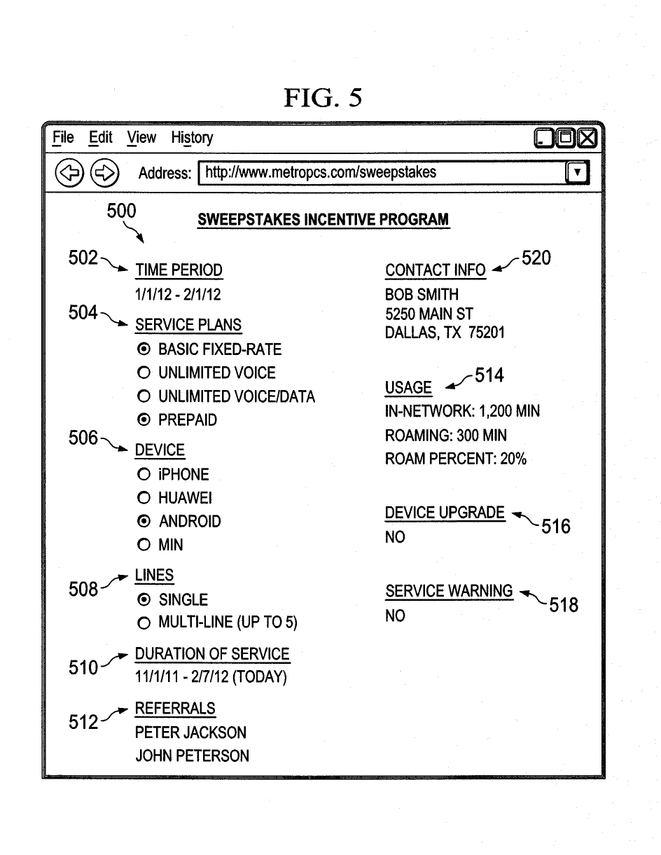

FIG. 5 is a screen shot of an illustrative user interface that lists information that may be utilized in conducting the sweepstakes incentive program;

FIG. 6 is a screen shot of an illustrative graphical user interface that allows for setting preferences of a customer for the sweepstakes incentive program;

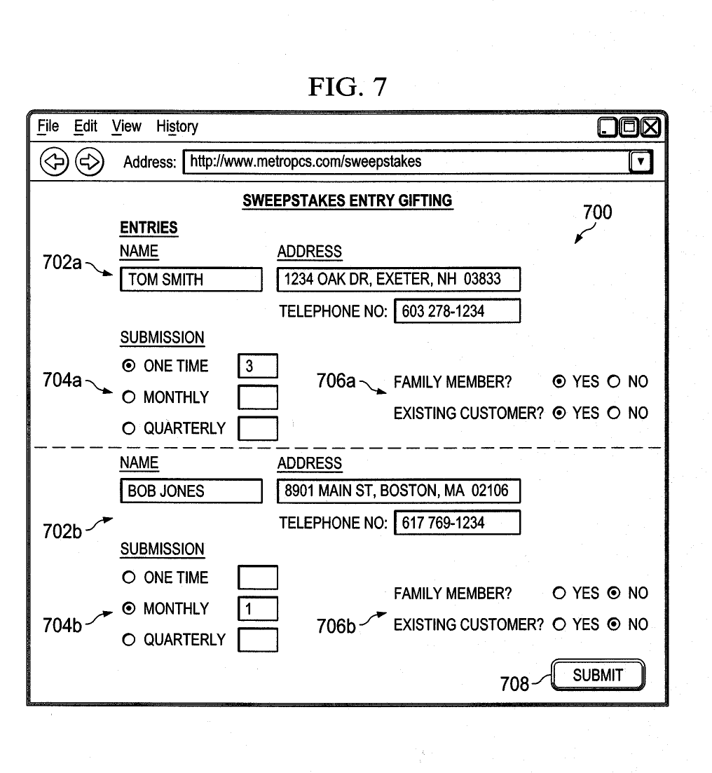

FIG. 7 is a screen shot of an illustrative graphical user interface that allows for a customer to perform entry gifting into the sweepstakes incentive program;

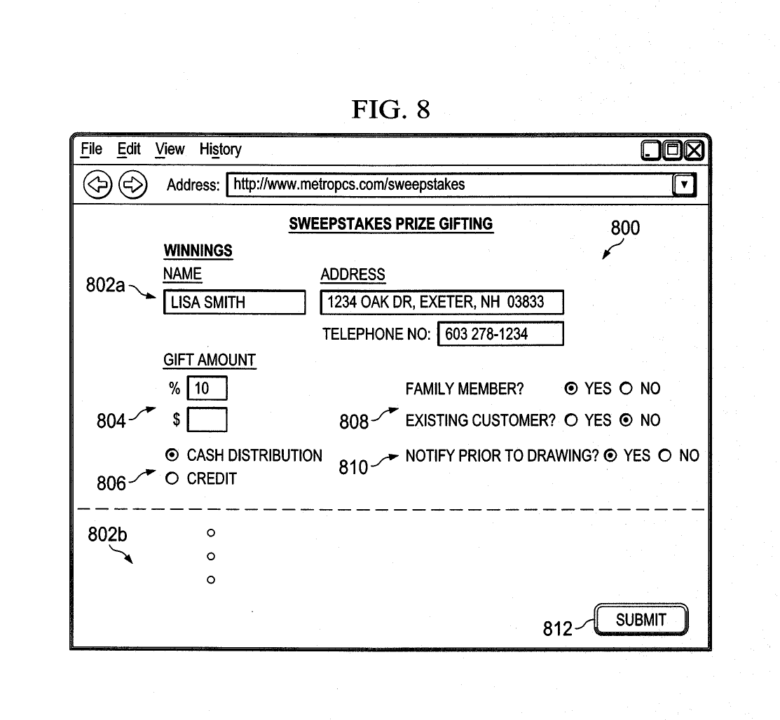

FIG. 8 is a screen shot of an illustrative graphical user interface that allows for a customer to perform prize gifting from winnings from the sweepstakes incentive program;

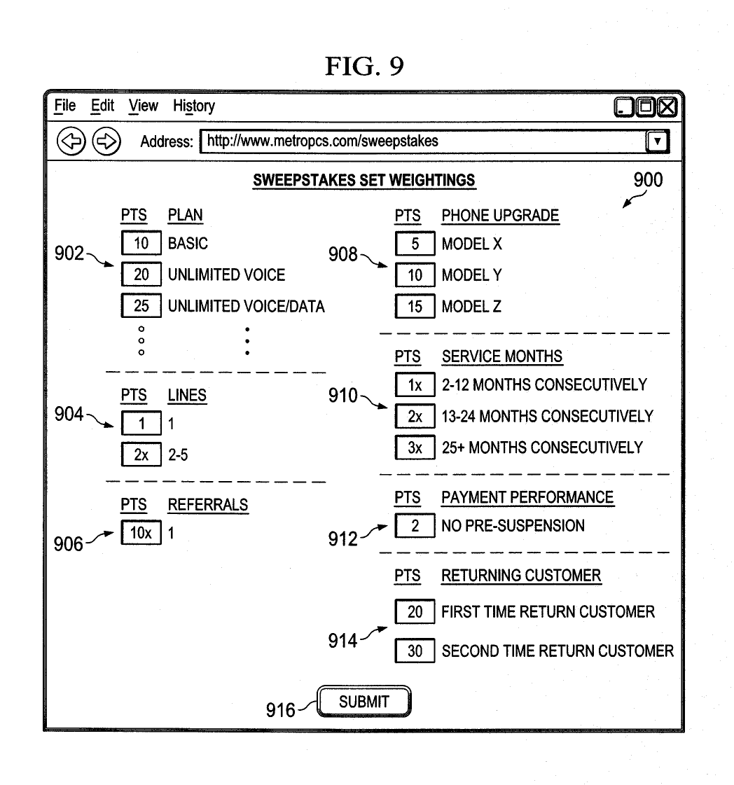

FIG. 9 is a screen shot of an illustrative graphical user interface that allows for the communications service provider to set weightings for customers to accumulate points for the sweepstakes incentive program;

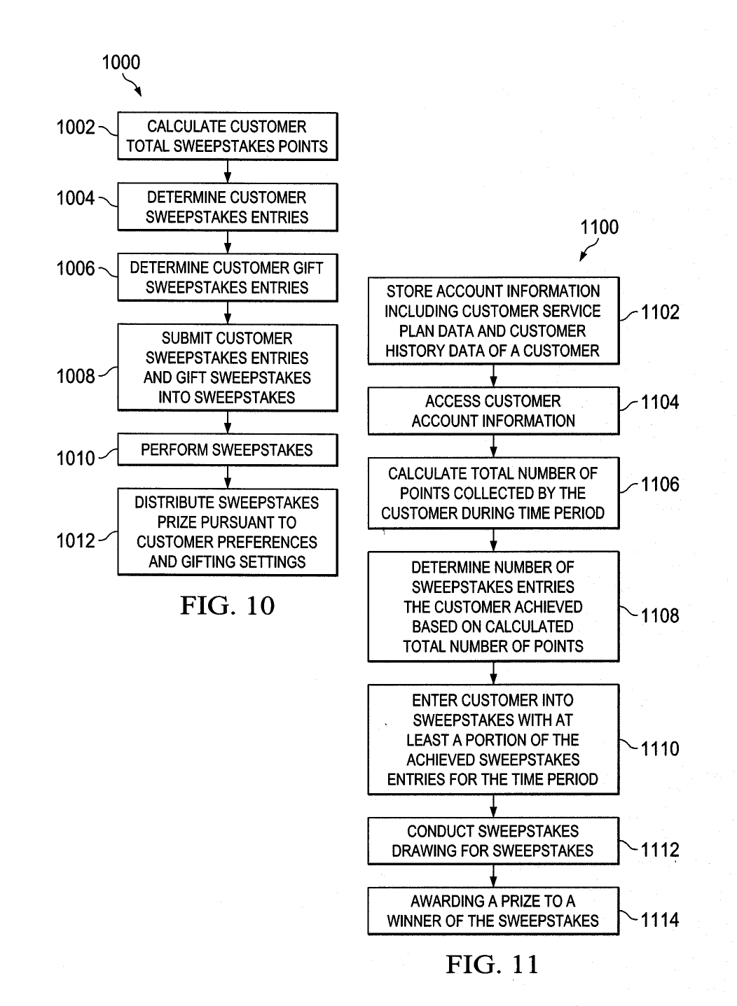

FIG. 10 is a flow diagram of an illustrative process for operating the sweepstakes incentive program; and

FIG. 11 is a flow diagram of an illustrative process for conducting a sweepstakes.

### DETAILED DESCRIPTION

With regard to FIG. 1, an illustration of an illustrative network 100 including a telecommunications service provider 102 that provides communication services to subscribers or customers 104a-104n (collectively 104) is shown. The customers 104 utilize mobile devices 106a-106n (collectively 106), respectively, for use in communicating via a communications network 108. The mobile devices 106 may be mobile telephones, wireless modems, smart phones, electronic gaming devices, or any other device that is configured to communicate via network 108, as understood in the art. It should also be understood that the principles of the present invention may provide for the communications service provider 102 to support non-mobile devices, such as personal computers or in-home appliances. Another network 109, such as a public switched telephone network (PSTN), the Internet, mobile telephone network, or other network, may provide for the customers 104 to communicate using mobile devices 106 to perform electronic communications 110a-11On (collectively 110) to devices 111 or 124, such as traditional telephones, servers, or other communications devices, as understood in the art. The mobile devices 106 may be utilized for performing electronic communications 110, including, but not limited to, telephone calls, video calls, and data communications (e.g., text messaging and instant messaging), that are communicated via the network 108 to other mobile devices 106 or to other devices 111 or 124. The communications 110 may utilize any communications protocol for communicating voice and/or data information over a communications medium, as understood in the art. Records of the communications 110 may be collected by the communications service provider 112 and recorded as customer history data, as further described herein, for use in a sweepstakes incentive program 112.

The sweepstakes incentive program 112 may be utilized by the communications service provider 102 for reducing churn of the customers 104. The sweepstakes incentive program 112 may enable the customers 104 to be entered or selectively enter themselves into a sweepstakes that is performed on a periodic basis, for example. In one embodiment, the periodic basis may be monthly, which incentivizes the customers 104 to continuously maintain a prepaid relationship, pay-as-you-go relationship, pay-in-advance relationship, subscription relationship, or any other customer relationship with the communications service provider 102, as described further herein below. In one embodiment, customer service plan information 114 and customer history information 116 may be communicated to the communications service provider 102 and stored in a customer account records repository 118.

The customer account records repository 118 may included sub-repositories, including a customer service plan data repository 120 and customer history data repository 122. In one embodiment, the repositories 118, 120, and 122 are integrated with one another, as shown, and managed by the communications service provider. Alternatively, the repositories 118, 120, and 122 are managed by a third-party service provider (not shown). In an alternative embodiment, the repositories 118, 120, and 122 may be distinct from one another and the sweepstakes incentive program 112 may have access to each of the repositories independently. It should be understood that the actual configuration and location of the repositories 118, 120, and 122 may vary and provide for the same or similar functionality in providing for the sweepstakes incentive program. In one embodiment, the sweepstakes incentive program 112 may actual be conducted by a third-party service provider (not shown) affiliated with the communications service provider that is provided access to the repositories 118, 120, and 122. Although the customer account records 118 shows two data repositories, including the customer service plan data repository 120 and customer history data repository 122, it should be understood that additional data repositories (see FIG. 4) may be included as part of the customer account records repository 118 and, optionally, utilized by the sweepstakes incentive program 112.

The customer service plan information 114 may be communicated to the communications service provider 102 by the Internet, storefront, telephone customer service, or self-service on-line means as a result of the customers 104 setting up or modifying the accounts with the communications service provider 102. The customer history information 116 may be communicated to the communications service provider 102 as a result of the customers 104 utilizing the mobile devices 106. Although the customer service plan information 114 and customer history information 116 are shown to be communicated to the communications service provider 102, it should be understood that the communications service provider 102 may generate one or both of the customer service plan information 114 and customer history information 116 that are to be stored or have stored and/or utilized by the communications service provider 102 in operating the sweepstakes incentive program 112.

With regard to FIG. 2, a block diagram of an illustrative computing system 200, shown here as a communications service provider (CSP) server, may be configured to operate the sweepstakes incentive program 112 for the communications service provider 102 of FIG. 1. The computing system 200 may include a processing unit 202 that may include one or more computer processors configured to execute software 204. The software 204 may be configured to perform a variety of different management and functional operations for the communications service provider, including operating the sweepstakes incentive program or sweepstakes. The processing unit 202 may be in communication with a memory 206 that is configured to store data, such as sweepstakes data (see FIG. 4), and software being utilized by the processing unit 202. The processing unit 202 may further be in communication with an input/output (I/O) unit 208 that is configured to communicate over a communications network, such as network 108 or network 109 of FIG. 1. The processing unit 202 may also be in communication with storage unit 210 that is configured to store one or more data repositories 212a-212n (collectively 212). The data repositories 212 may be configured to store customer information associated with each of the customers 104 of the communications service provider 102. The data repositories 212 may further be configured to store sweepstakes information associated with the sweepstakes incentive program. It should be understood that the data repositories may be stored in one or more storage units and that a variety of different data structures May be utilized in managing the information associated with the customers 104 and sweepstakes incentive program 112. Although shown as a single computing system 200, it should be understood that multiple computing systems, as understood in the art, may be utilized in conjunction with one another in accordance with the principles of the present invention.

With regard to FIG. 3, a block diagram of illustrative software modules 300 that may be part of the software 204 of FIG. 2 may be utilized to operate the sweepstakes incentive program 112 (FIG. 1). Although the software modules are shown to be independent of one another, it should be understood that the software modules 300 may have alternative configurations, such as having multiple functionalities within a single module or having different and/or additional software modules from those shown.

A manage customer contact module 302 may be configured to store customer name, home address, telephone number, email address, work address, or any other information that may be utilized by the communications service provider to contact a customer. In one embodiment, the manage customer contact module 302 may be configured to store the information associated with a customer as well as information associated with other customers and non-customers to enable the communications service provider to communicate with the other customers or non-customers in association with conducting the sweepstakes incentive program 112. For example, if a customer designates a non-customer to receive sweepstakes winnings, then the contact information of the non-customer may be utilized in the event that the customer wins the sweepstakes.

A manage customer account module 304 may be configured to manage a customer's account with the communications service provider. The module 304 may manage data that the communications service provider uses in providing communications services to the customer, such as a communications service plan for which the customer pays, number of lines associated with the customer, duration of service, home location, services or features used by the customer, type of customer communication device, and so on Data that is managed by the manage customer history module 304 may be utilized in association with the sweepstakes incentive program 112 by the customer receiving points or other value based on the data associated with the customer account. In one embodiment, the data associated with the customer account being managed by the module 304 may be utilized to affect a weighting factor that is used in determining or calculating a number of points for a customer that can be converted into sweepstakes entries for submission into the sweepstakes incentive program 112. Alternatively, rather than being used to generate points, the data associated with a customer account may be directly converted into sweepstakes entries. For example, if a customer has a certain level communications plan, then the customer may receive one sweepstakes entry per month, as opposed to receiving a certain number of points that may then be converted into sweepstakes entries.

A manage customer history module 306 may be configured to manage data associated with history of a customer for account history (e.g., activation date, prior service plans, payment history) and usage information (e.g., number of text messages sent each month). More specifically, the module 306 may track a customer's usage, including roaming, data usage, voice communications usage, international calling usage, multi-party calling usage, numbers of calls made, numbers of calling minutes, and so forth. The customer history data managed by the module 306 may be utilized by the sweepstakes incentive program for creating value, such as accumulating points, adjusting a weighting factor, and/or creating sweepstakes entries directly.

A calculate total points module 308 may access the customer history data being managed by the manage customer history module 306 and calculate a total number of points over a given time period that the customer has achieved for use in submitting sweepstakes entries. In other words, a customer may accumulate points having a certain service plan, device, number of lines, usage history, and so forth during a month, and the calculate total points module 308 may accumulate the points from the different sweepstakes categories to generate a total number of points. Each sweepstakes entry may require a certain number of points, such as 1000 points, and the accumulation of the points from the different sweepstakes categories may be used to collect and submit sweepstakes entries in a sweepstakes for some given time period, such as monthly. By allowing the customer to accumulate points in a variety of different categories, the customer may be incentivized to have certain behaviors, such as to upgrade communications devices more often, accumulate fewer roaming charges, have more lines, have a higher priced service plan, and so forth. By influencing behavior with the sweepstakes incentive program, higher revenue, lower costs, and less churn may result for the communications service provider.

A manage customer sweepstakes preference module 310 may be utilized to enable the communications service provider to manage preferences of a customer for the sweepstakes incentive program 112 (FIG. 1). The module 310 may provide an interface, such as a graphical user interface (GUI), that allows a customer to enter preference information into the system. For example, the module 310 may enable the customers to enter certain information, such as a number of monthly entries, payout desires should the customer win a sweepstakes, which sweepstakes to enter, and so on, as shown and described further herein with regard to FIG. 6.

A submit sweepstakes entries module 312 may enable the sweepstakes system to submit entries from the customers into the sweepstakes. In one embodiment, the submit sweepstakes entries module 312 may utilize a customer's preferences as established with the module 310 to determine how many sweepstakes entries, if any, to submit for a customer for each sweepstakes. For example, if a customer has enough points to submit 10 sweepstakes entries, but has elected to submit only one sweepstakes for a given sweepstakes, then the submit sweepstakes entries module 312 will submit the desired one entry for the customer and maintain the remaining points in the customer's account. The submit sweepstakes entries module 312 may further be configured to submit sweepstakes entries or gifted sweepstakes entries to other individuals, who may be customers or non-customers, as further described herein.

A verify customer name and address module 314 may be configured to, in response to a customer winning a sweepstakes, compare the customer's name and address provided upon showing identification to the communications service provider when the customer accepts the winnings from the sweepstakes, with a name and an address being maintained by the manage customer contact module 302. One reason for comparing and verifying the customer address is to ensure that the customer's address is within a location served by the communications service provider, as a customer whose primary residence is within a roaming area may violate terms and conditions of the customer's subscription with the communications service provider. One reason for comparing and verifying the customer's name and address is to provide accurate taxing information for the communications service provider for communications taxes. In response to the module 314 determining that the customer's name and address provided when collecting his or her sweepstakes winnings does not match the customer's name and address being managed by the manage customer contact module 302, the communications service provider may be notified of the discrepancy of the addresses, and, optionally, automatically determine whether the actual or current address of the customer is not within coverage area of the communications service provider. In addition, if the module 314 determines that the customer has been violating the terms and conditions of the communications service provider with regard to the customer's actual name and address, then the module 314 may flag the customer and/or communications service provider of the violation, thereby enabling the communications service provider to discontinue providing communications services to the customer and bar the customer from collecting on winning the sweepstakes.

A customer gifting module 316 may be utilized to enable customers to be able to gift points, sweepstakes entries, and/or sweepstakes winnings to someone other than the customer who is receiving points for being a customer of the communications service provider. The customer gifting module 316 may provide a GUI with which a customer may interface to establish recipients of gifts. In addition, the data collected by the customer gifting module 316 may be utilized by the submit sweepstakes entries module 312 for submitting gifted sweepstakes entries into a sweepstakes. The customer gifting module 316 may collect information, including name and contact information, associated with people that a customer wishes to gift sweepstakes entries, points, and/or sweepstakes winnings. This information may also be used by the communications provider to selectively target for sales of the services.

A manage customer winnings module 318 may be configured to manage winnings of a sweepstakes for customers. The manage customer winnings module 318 may enable the communications service provider to associate the winnings with particular customers, and enable the customers to be paid or otherwise compensated as a result of winning a sweepstakes. The winnings of a sweepstakes may be in the form of cash, credit, services, downloads, such as movies, apps, or any other data content, roaming minutes, tangible or intangible gifts, or any other incentive of value to the customer.

A manage sweepstakes weightings module 320 may be configured to apply weightings to one or more sweepstakes categories or categories of services, such as a service plan, roaming charges, cost of providing services to the customer, number of lines assigned to a customer, frequency of mobile device upgrades, type of mobile device being utilized by a customer, data plans, voice plans, frequency spectrum being utilized by a customer, number of continuous months of being a customer, number of months without having a late payment, number of months without being on probation or having service disconnected, location of payment, form of payment, using automatic payment, or any other factor that may incentivize a customer to remain being a customer or otherwise benefit the communications service provider for having that customer. As an example, if one frequency spectrum is more efficient than another frequency spectrum, then the communications service provider may give a higher weighting factor to a customer for using the more efficient frequency spectrum. Providing a higher weighting factor to a customer who uses a more efficient frequency spectrum tends to incentivize more efficient use behavior by customers.

The weightings may be in the form of points given to a customer on a periodic basis (e.g., monthly), weighting factor multipliers (e.g., 0.5, 1.0, 2.0, etc.) that are used to multiply a certain number of points (e.g., 1000 points), or any other value that increases a number of points or sweepstakes entries received by a customer for submission into a sweepstakes incentive program. In one embodiment, the module 320 may be configured to allow different weightings for different sweepstakes incentive programs, such as monthly and quarterly sweepstakes.

A user interface module 322 may be configured to enable users at the communications service provider or customers of the communications service provider to interface with the sweepstakes system for performing one or more of the functions as provided with respect to any of the modules 300. The user interface module 322 may provide for Internet or intranet access so that customers of the communications service provider may access their accounts and users at the communications service provider can access the accounts of customers and management functionality for the communications service provider. The user interface module 322 may interface with any of the other modules 300 or data being managed, collected, and/or generated by any of the modules 300, as described herein.

A sweepstakes reporting module 324 may be configured to provide reporting functionality of the sweepstakes incentive program for customers and the communications service provider. The sweepstakes reporting module 324 may, for example, provide reporting to customers via a communications network, such as the Internet, mobile telephone network, public switched telephone network, or any other communications network to report on results of a sweepstakes, number of entries in the sweepstakes, number of points available for conversion to sweepstakes entries, calendar of sweepstakes, or any other information that may enable the customers to participate in the sweepstakes incentive program or receive information associated with the sweepstakes, thereby further motivating customers to remain customers of the communications service provider. The reporting may be in the form of paper (e.g., on bills) or electric report (e.g., email, text message, or posted on a website). Reporting to the communications service provider may include statistics reporting (e.g., average length of time that participating sweepstakes customers have been customers, total number of customers in different service plans, etc.), names of winners, current number of sweepstakes entries, and so on.

A conduct sweepstakes module 326 may be configured to accept and/or access sweepstakes entries for the customers or their gifted individuals and perform a sweepstakes. The sweepstakes may include selection of one or more sweepstakes entries for a given time period. The conduct sweepstakes module 326 may be configured to operate one or more sweepstakes, such as monthly sweepstakes, quarterly sweepstakes, special sweepstakes, holiday sweepstakes, or any other sweepstakes being offered by the communications service provider. The results of the conduct sweepstakes module 326 may be stored and other modules, such as the sweepstakes reporting module 324, may access that sweepstakes information and perform appropriate functionality, such as reporting to winners of the sweepstakes.

An award sweepstakes module 328 may be configured to access or receive the results from the conduct sweepstakes module 326 and award the winners of the sweepstakes. In awarding the winners of the sweepstakes, the module 328 may operate in conjunction with the verify customer name and address module 314 and manage customer winnings module 318 to ensure that the customer is authorized to be awarded a prize prior to awarding the prize. The module 328 may cause the prize to be awarded manually, semi-automatically, or automatically. If a cash award is to be made, then the module 328 may initiate a check issuance, wire transfer, or other financial payment, as understood in the art, by generating a request, sending instructions, causing a check to be printed, or otherwise. If credit is to be given to the winner, then a credit balance may be applied to a financial system, such as an accounting system that maintains balances for customers. The module 328 may further cause a data repository, such as the customer history data repository, to be updated to indicate a date that the prize was awarded. If the award winner is not a customer, then a data repository may be updated to include information associated with the winner of the prize.

With regard to FIG. 4, a table of illustrative customer account records 400 that, in part, may be utilized in supporting the sweepstakes incentive program is shown. The records 400 may include customer service plan data 402, customer device data 404, customer history data 406, customer contact information 408, customer sweepstakes preferences information 410, and customer sweepstakes data 412. The customer service plan data 402 may include a type of plan that the customer currently has, such as unlimited voice, unlimited data, prepaid, post paid, or any other parameter that defines a type of service plan that the customer is currently using. As previously described, the type of service plan that the customer has may provide a certain value, such as points, sweepstakes entries, or weighting, that a customer receives for participation with the sweepstakes incentive program being offered by the communications service provider. The customer device data 404 may store information descriptive of a device, including make, model, type, serial number, communications protocol, and so forth. The data 404 may further include historical information of each device owned by the customer. The customer history data 406 may include a variety of different parameters, including previous service plans, amount of usage, including voice and data, number of total minutes, number of roaming minutes, number of calls, number of three way calls, international calls, and an any other during a time period, such as a month.

The customer contact information 408 may include contact information of the customer, including telephone number, home address, work address, home telephone number, etc. The customer sweepstakes preferences information 410 may include preferences, such as payout, number of entries per sweepstakes, and other preference information that customers may desire and the communications service provider may want to utilize for managing the sweepstakes incentive program. The customer sweepstakes data 412 may include a number of sweepstakes entries that a customer submits, number of points that a customer has collected, for one or more categories, total number of points that a customer has available for conversion to sweepstakes entries, and any other information that a customer and sweepstakes incentive program may utilize. The customer sweepstakes data 412 may further include historical data, such as previous numbers of sweepstakes entries entered in each sweepstakes that the customer participated in, gifting information associated with the sweepstakes (e.g., names of people to whom the customer gifted sweepstakes entries and number of sweepstakes entries submitted for each of the people), historical winnings, particular sweepstakes in which a customer participated, and so forth.

With regard to FIG. 5, a screenshot of an illustrative user interface 500 that lists information 502-520 that may be utilized in conducting a sweepstakes incentive program for or by a communications service provider is shown. The information shown in the user interface 500 may include a time period 502 during which the information is used for the sweepstakes incentive program. As shown, the time period ranges between Jan. 1, 2012 and Feb. 1, 2012. The service plan information 504 may show a listing of plans and plan options that the customer has selected or is available to select. In one embodiment, the service plan information 504 may allow for selection or change of a service plan for the customer. Alternatively, the service plan information 504 may simply list a current service plan and/or service plan options that the customer has selected. As shown, the user has selected a basic fixed-rate service plan that is prepaid.

The service plan information 504 shown is illustrative and not exhaustive, and that a larger list with a variety of different plans and options may be utilized based on actual service plan options provided by the communications service provider. Each of the selected service plans and plan options may provide a certain number of points or, alternatively, affect a weighting factor that are used to determine a number of points that the customer receives during the time period. Alternatively, the selected service plan and plan options may provide directly (e.g., without using points) sweepstakes entries for submission in a sweepstakes incentive program for the time period.

The device information 506 may list communication device(s) that are available and/or owned by the customer. The device information 506 may list mobile devices, gaming devices, fixed location devices (e.g., desktop computer), and any other devices. In one embodiment, the different type of devices may be hierarchically listed based on device type, operating system, manufacturer, and so forth to more easily allow a user to view and/or select device(s) being used by the customer. As previously described, the sweepstakes incentive program may award more value for use of one device over another (e.g., more expensive devices that are purchased from the communications service provider or require more expensive service plans provide more value (e.g., points) for a sweepstakes incentive program).

The lines information 508 may show that the customer has a single line or multi-line service. If the customer has a single line, a sweepstakes entry value, such as a certain number of points, adjustment to the weighting factor, or sweepstakes entries may be provided to the customer during, at the close of, or after the time period 502. As shown, the customer has a single line. If the customer has a multi-line service plan, then the customer would receive additional points, for example, for the sweepstakes incentive program during the time period 502. Although simply shown as a single line and multi-line (up to 5), it should be understood that the multi-line option may allow for a user to enter an exact number of lines (e.g., 3 lines), and the customer would receive a certain number of points, for example, for each of the three lines, thereby providing additional granularity for the sweepstakes incentive program.

The duration of service information 510 may provide a listing of the amount of time that the customer has had service with the communications service provider. Although shown as a simple start date and end date, it should be understood that a full listing of multiple dates of service (e.g., different service dates started and ended if the customer has been a customer multiple, non-continuous times). In addition to listing the dates and/or duration of service, additional information associated with those dates of service may include whether the customer chose to end service, whether the customer had any probations during the service, or whether the service was cancelled as a result of the customer violating terms and conditions, for example. If the customer has had continuous service without interruption, suspension, or cancelation, then the customer may receive more points for the sweepstakes than if the customer has received a violation or suspension during the dates of service. If the customer has had multiple continuous months of service, quarters of service, or years of service, then the customer may receive additional sweepstakes value, such as points, adjustments to a weighting factor, or sweepstakes entries into a sweepstakes incentive program. In one embodiment, if the communications service provider has a quarterly sweepstakes that requires the customer to be a customer for an entire quarter, then the duration of service information 510 may be utilized to determine whether or not the customer may enter the quarterly sweepstakes and how many points, for example, the customer receives for entering the quarterly sweepstakes. If the customer has been a customer of the communications service provider for two or more consecutive quarters, then the customer may receive additional sweepstakes value for participation in the quarterly sweepstakes. Alternative and/or additional uses of the duration of services information 510 may be utilized in accordance with the principal for the present invention.

The referrals information 512 may be utilized to add additional points, adjust the weighting factor, or provide additional entries into a sweepstakes incentive program. As shown, the customer has provided two referrals to the communications service provider so that the communications service provider may market to the referral so as to attempt to enroll the referrals as customers into a communications service program. Although shown as two referrals, it should be understood that the number of referrals may be extensive and that the customer may receive additional points, for example, based on the total number of referrals during the time period 502. In addition to the referral simply being listed for the given time period 502, the total number of referrals during the duration of service 510 may be listed and the customer may receive additional points, for example, based on the total number of referrals during the duration of service 510. In one embodiment, referrals may be listed and any of the referrals that actually become customers may be separately listed or otherwise identified. Alternatively, referrals may be considered to be actual referrals after being legitimized (i.e., not fictitious names) by the communications service provider either automatically (e.g., verification by a computer on a database or otherwise) or manually (e.g., call to the referral). The customer may receive a certain number of points for submission of referrals and receive additional points for any of the referrals who become customers. Still yet, if any of the referrals become customers by purchasing certain communications service plans or plan options, the customer may receive additional points, for example, for the sweepstakes incentive program. In addition to receiving immediate or short term sweepstakes value, a customer may receive long-term sweepstakes value of the referral customer(s) remain long-term customer(s) (e.g., referral customer remain a customer for one or more entire quarters). In one embodiment, bonuses may be given to referring customers based on the types or amount of services purchased by referral customers.

The usage information 514 may include a variety of different usage information as performed by the customer during the time period 514. As shown, the usage information 514 may include in-network usage minutes, roaming minutes, and roaming percentage. The usage information may include a wide range of different usage parameters. For example, international calling usage, data messaging usage, data download usage, gaming usage, 3-way calling usage, and so forth, may be tracked and displayed. The different usage parameters may be used in providing value, such as points, weighting factor, and/or sweepstakes entries. In one embodiment, an increase in certain parameters, such as roam percentage, may decrease the amount of value that the customer generates towards sweepstakes entries. That is, if a parameter costs the communications service provider more to support the customer, then the customer may be adversely affected in his or her sweepstakes participation. The communications service provider may control which usage parameters affect value for participation in the sweepstakes, so that the communications service provider may increase usage parameters that make supporting a customer more profitable and give little, no, or negative sweepstakes value to usage parameters that make supporting a customer less profitable.

The device upgrade information 516 may indicate whether the user upgraded his or her device (e.g., mobile phone) during the time period 502. In addition, the device upgrade information 516 may show historical information, such as last device upgrade or a listing of all previous device upgrades. Still yet, the device upgrade information 516 may list a device upgrade frequency value (e.g., average upgrade 1.3 years). The sweepstakes may provide more value for a customer to upgrade at a higher frequency than a lower frequency of device upgrade frequency. For example, a customer may earn a certain value, such as 50 points per month, for customers who upgrade devices within a threshold time period, such as 1 year, and earn less value for customers who upgrade devices less than a threshold time period, multiple threshold time periods, such as 6 months, 1-year, and 2-years may be utilized to determine how much sweepstakes value, if any, is to be given to a customer.

The service warning information 518 may list whether or not the customer entered into a pre-suspension or “hot-line” status during the time period 502. A pre-suspension status is a warning to the customer and communications service provider that is indicative of the customer's failure to pay for the communications service, using the service in violation of terms and conditions, or otherwise. It should be understood that in addition to showing information 518, other status information, such as a full suspension, may be shown. If the customer is shown to enter a pre-suspension status, then the customer may not be awarded or otherwise lose value, such as points, for the sweepstakes for the time period 502. Of course, if the customer has not entered a pre-suspension status, then the customer may gain value for the sweepstakes. In one embodiment, rather than simply showing the pre-suspension status, a total time period (e.g., months or quarters) without entering pre-suspension status may be shown and utilized for providing value for the customer in participating in the sweepstakes.

The contact information 520 may include contact information of the customer, including name, home address, work address, email address (not shown), telephone number (not shown), or other contact information. In one embodiment, the contact information 520 is utilized after a sweepstakes to validate that the customer is located in a service area of the communications service provider, and that the customer, should he or she win, is the actual customer.

With regard to FIG. 6, a screen shot of an illustrative user interface, shown here as a graphical user interface, 600 that allows for setting preferences of a customer for the sweepstakes incentive program. The GUI 600 may provide a GUI element 602 that allows for a customer or other user (e.g., employee of the communications service provider) to select how many sweepstakes entries that the customer desires to submit in a sweepstakes. As shown, the customer may select from “MAX,” “REQ,” and “1,” which means that the customer may elect to submit (i) a maximum number of entries for each available sweepstakes, (ii) requested number of entries for each available sweepstakes, or (iii) one entry for each available sweepstakes. If the election is a maximum number of entries, all available points that are available to the customer during a time period may be converted to sweepstakes entries. For example, if a sweepstakes entry is 10 points and the customer has earned 100 points during the time period, then the sweepstakes system enters 10 sweepstakes entries into the sweepstakes for the customer. If the election is a requested number of entries, then the customer may request a certain number of sweepstakes that may be less than the total available number of sweepstakes entries of which the customer has earned. That is, if the customer has earned 10 sweepstakes entries (e.g., 100 points and 10 points per sweepstakes entry), then customer may request to submit fewer than 10 sweepstakes entries into the sweepstakes. If the customer elects the “REQ” option, then another GUI element, such as a text entry field, may be provided to the user to enter a number of sweepstakes entries for the sweepstakes. In one embodiment, a message may be sent to the customer prior to the sweepstakes to request the number of sweepstakes entries relative to the total number of sweepstakes entries available.

As further shown, the customer may select from an illustrative GUI element 604 whether to have winnings from a sweepstakes that allows for a winner to receive a financial return be paid in “cash,” “credit,” or “periodic.” If the customer selects to be paid in cash, the customer may be mailed a check, wired money into a bank account, or otherwise be paid in a cash equivalent manner. With a cash payout, a reduced payout may be made to account for present value of the winnings, as understood in the art. If the customer selects to be paid in credit, the customer may have a credit balance with the communications service provider so that future services, such as communications services, data services, downloads, etc., may be debited against the credit balance. If the customer selects a periodic payout, then the customer may be paid the entire winnings over a longer period of time, such as 5 years. If the sweepstakes provides for non-financial awards, such as new electronic devices, then other GUI elements may be provided for the customer to select different prizes (e.g., different brands of phones).

The sweepstakes preferences may also include an illustrative listing 600 of available sweepstakes 606 from which the customer may elect to enter sweepstakes entries. As shown, monthly sweepstakes and quarterly sweepstakes are available for entry. If the customer selects to enter into monthly sweepstakes, then sweepstakes entries, as elected above in the GUI (e.g., “MAX”), may be submitted in each monthly sweepstakes while the customer is a customer of the communications service provider. The customer may select none, either, or both of the monthly and quarterly sweepstakes. Information, such as jackpot odds and winning odds, may be posted in association with the different sweepstakes. It should be understood that additional or alternative sweepstakes selections, such as specific prizes (e.g., new mobile phone, automobile, etc.) associated with specific sweepstakes, may also be available for a customer to select in accordance with the principles of the present invention.

With regard to FIG. 7, a screen shot of an illustrative graphical user interface 700 that allows for a customer to perform entry gifting into the sweepstakes incentive program is shown. The GUI 700 may provide for a customer to gift entries into a sweepstakes to someone else, including customers or non-customers of the communications service provider. Entry information 702a and 702b may provide for the customer to enter name and contact information. Submission information 704a and 704b may allow for the customer to select which sweepstakes and how many entries to enter for the associated gifted person or giftee. As shown, Tom Smith is being gifted to be entered into a one time sweepstakes (e.g., the next sweepstakes that the communications service provider conducts) with three entries. The entries are reduced from the customer's available sweepstakes entries or points, for example.

Additional gifting information 706a and 706b may be requested from the customer to indicate whether the person being gifted sweepstakes entries is a family member and/or existing customer of the communications service provider. In one embodiment, the customer may be able to select a member of points or other sweepstakes value to transfer to another customer, family member or otherwise, and the sweepstakes system may transfer the sweepstakes value accordingly. It should be understood that additional and/or alternative information may be requested in accordance with the principles of the present invention. For example, the customer may be requested to submit age of the gifted person, as minors may be prevented from being entered into the sweepstakes. Still yet, the customer may be requested to submit what carrier a person currently uses if the gifted person is not an existing customer. Upon completion of entering sweepstakes entry gifting information, the customer may select a “submit” soft-button 708.

With regard FIG. 8, a screen shot of an illustrative graphical user interface 800 that allows for a customer to perform prize gifting from winnings from the sweepstakes incentive program is shown. The GUI 800 may provide for a customer to submit information 802a and 802b, including name and contact information, associated with individuals who the customer desires to have an opportunity to share or receive winnings of a sweepstakes in the event that the customer wins the sweepstakes. The contact information 802 may also include an email address, home address, work address, and/or mobile device telephone number of the individual. In addition, the GUI 800 may provide GUI element(s) 804 for a gift amount to be specified in the form of a percentage or fixed amount. Selection elements 806 may further provide for a customer to select whether to have the winnings distributed as cash or credit distributions to the individual. If the individual is not a customer of the communications service provider, then providing the customer with credit may require the non-customer to become a customer for essentially free communications services from the communications service provider. GUI elements 808 may enable the customer to provide additional information, such as whether the individual is a family member and existing customer of the communications service provider. Although not shown, the GUI 800 may require a social security number to be submitted for tax purposes. Alternatively, such tax information may be requested directly from the individual after the customer wins the sweepstakes, but before payout to the individual. In one embodiment, the customer may select whether or not to notify the individual prior to the drawing by selecting a GUI element 810 (e.g., “YES” or “NO” selection elements). If the customer selects to notify the individual, then the individual may be notified in response to the customer selecting the “submit” soft-button 812 to submit the prize gifting. In one embodiment, age of the individuals may be requested to ensure the individual is 18 years of age or older.

With regard to FIG. 9, a screen shot of an illustrative graphical user interface 900 that allows for the communications service provider to set weightings for accumulating points for the sweepstakes incentive program is shown. The GUI 900 includes a number of different illustrative weighting categories, including plan 902, lines 904, referrals 906, phone upgrade 908, service months 910, payment performance 912, and returning customer 914.

The plan category 902 may include points for different service plans. For example, a basic plan may provide 10 points, unlimited voice plan may provide 20 points, and unlimited voice/data plan provide 25 points. Other plans and plan options, such as a prepaid plan option, may provide the customer with the same or different points. Although shown as points, it should be understood that rather than issuing points to the customer that weighting factors or increases in a weighting factor may be given to the customer for having a certain plan or plan options. For example, a customer may receive a weighting factor of 1.0 for having a basic plan, 1.2 for having an unlimited voice plan, and 1.5 for having an unlimited voice/data plan. Essentially, the more expensive the service plan, the more sweepstakes value the customer may receive for the sweepstakes incentive program. Although not shown, the communications service provider may provide more sweepstakes value for service plans that are more efficient in terms of bandwidth usage than service plans that utilize less efficient bandwidth usage (e.g., 20 points for 3G service and 30 points for 4G service).

The lines category 904 may provide the customer with different points for having a different number of lines. As shown, if the customer has a single line, the communications service provider may give 1 point, while if the customer has multiple lines up to five lines, then the customer may receive 2 points for each of the lines. If the customer has over five lines, then the customer may simply receive 10 points. The number of points may be accumulated for each month that the customer has the lines.

The referrals category 906 may provide a total number of valid referrals that the customer provided during the month. As shown, the customer provided one valid referral, and the communications service provider is offering 10 points for each referral. Again, rather than giving points, the communications service provider may give additional value to a weighting factor. Still yet, rather than giving the customer points or weighting factor value, the communications service provider may simply give the customer sweepstakes entries as a sweepstakes value incentive as opposed to points or weighting factor value that may later be converted into sweepstakes entries.

The phone upgrade category 908 may enable the communications service provider to offer more points for a customer to upgrade his or her device to a particular model and/or brand of device, such as mobile phone. As shown, Model X provides fewer points than Model Z since Model Z is more expensive to purchase and/or receive service from the communications service provider. Model Z may also be less costly in terms of bandwidth than Model X, so the communications service provider may provide more sweepstakes value for Model Z to incentivize customers to purchase Model Z over Model X. Device makers may also incentivize customers to purchase their devices and may offer promotional sweepstakes (e.g., 5 sweepstakes entries with purchase of mobile phone).

The payment performance category 912 may provide a customer with points should the customer not be or enter into a pre-suspension (or suspension) status with the communications service provider. The pre-suspension status may occur when the customer is late in payment, violates terms and conditions of his or her service plan, or otherwise. It should be understood that rather than simply giving a fixed number of points for having no pre-suspensions for a month, that a variable number of points may be given to a customer for having multiple, consecutive months of not having a pre-suspension or other violation of terms an conditions of the service plan. For example, if the customer has had six consecutive months without a pre-suspension, then the customer may receive 12 points in the sixth month (e.g., 2 points per consecutive month).

As an alternative example of applying the weightings, TABLE I below shows an illustrative listing of weighting factor (WF) values that a communications service provider may utilize. It should be understood that the parameters, weighting factors, and points shown in TABLE I are illustrative and not intended to be exhaustive, and that alternative parameters, weighting factors, and points may be utilized in accordance with the principles of the present invention.

TABLE I

| | Weighting | Points |
|---|---|---|
| Parameters | Factors | (base points 1000) |
| Service Plans | | |
| Basic | 1.0 | 1000 |
| Unlimited Voice | 1.2 | 1200 |
| Unlimited Voice/Data | 1.4 | 1400 |
| Prepaid | 0.25 | 250 |
| Post-Paid 1-Year Subscription | 0.5 | 500 |
| Lines | | |
| 1 Line | 0.01 | 10 |
| 2-5 Lines | 0.02x | 20 |
| 5+ Lines | 0.03x | 30 |
| Referrals | | |
| 1-5 | 0.02x | 20 |
| 6-10 | 0.04x | 40 |
| 11+ | 0.05x | 50 |
| Phone Upgrade | | |
| Model X | 0.05 | 50 |
| Model Y | 0.10 | 100 |
| Model Z | 0.15 | 150 |
| Consecutive Service Months | | |
| 2-12 Months | 0.01x | 20-120 |
| 13-24 Months | 0.015x | 195-360 |
| 25+ Months | 0.02x | 500 |
| Returning Customer | | |
| 1^{st} Time Return Customer | 0.5 | 500 |
| 2^{nd}+ Time Return Customer | 0.25 | 250 |
| . . . | . . . | . . . |

The selected parameters by a customer may be accumulated each time period (e.g., monthly or quarterly) and the summed total may be multiplied by a certain value (e.g., 1000 points) to compute a total number of points. The resulting number of points may thereafter be converted into sweepstakes entries. So, if 1000 points are needed for one sweepstakes entry, every customer with basic service is guaranteed to receive a sweepstakes entry, while a customer with higher levels of service, such as a basic, post-paid 1-year subscription is guaranteed 2 sweepstakes entries (i.e., WF=1.0+1.0=2.0, which, when multiplied by 1000 base points results in 2000 points, which is enough for 2 sweepstakes entries). Although not shown, the principles of the present invention may enable the communications service provider to apply weighting factors or negative weighting factors to various parameters, such as cost of service, number of service calls made by the customer, roaming charges, or any other cost utilized by the customer that is absorbed by the communications service provider in providing services to customers so as to reduce points accumulated by the customer. Another parameter that provides additional points to the customers may include customer participating in a marketing program that allows the communications service provider or its partners to send marketing materials or advertisements to the customer.

Upon a user of the communications service provider completing setting weightings for the sweepstakes incentive program, the user may select a “submit” soft-button 916. Once submitted, the weightings may be applied to the next sweepstakes that is held. It should be understood that different sweepstakes may have different weightings and that the weightings shown are illustrative. For example, a monthly sweepstakes may have different weightings than a quarterly or annual sweepstakes as the communications service provider may want to provide different incentives to customers for quarterly or annual sweepstakes than monthly sweepstakes. As previously described, rather than using points, the principles of the present invention may use different value for incentivizing customers that participate in the sweepstakes incentive program, including applying weighting factor value (e.g., 1.5 multiplier for unlimited data service plan, 0.5 for no pre-suspension) that is multiplied by a predetermined value (e.g., 1000 points) or directly applying sweepstakes entries (e.g., 2 sweepstakes entries for unlimited data service plan, 1 sweepstakes entry for no pre-suspension during a given month).

FIG. 10 is a flow diagram of an illustrative process 1000 for operating the sweepstakes incentive program. The process 1000 may start at step 1002, where calculation of a customer total sweepstakes points may be performed. The calculation may take the form of addition to add points for different sweepstakes categories, multiplication and addition to multiply points with values (e.g., 10 points per consecutive months of service), or otherwise. At step 1004, the process may continue to determine a number customer sweepstakes entries. The number of customer sweepstakes entries may be determined from the number of total points collected during a time period. If, for example, 50 points are needed to achieve a single sweepstakes entry and the customer earns 150 points, the customer earns three sweepstakes entries or have an opportunity to convert the points into three sweepstakes entries. In one embodiment, rather than simply entering three sweepstakes entries into a sweepstakes, the customer may elect to have only one sweepstakes entry submitted into a sweepstakes, a maximum number of sweepstakes entries submitted (i.e., in this case three sweepstakes entries would be submitted), or a select number of sweepstakes entries entered (i.e., in this case, the customer may choose to submit 0, 1, 2, or 3 sweepstakes entries) prior to the sweepstakes. Any remaining points or sweepstakes entries may remain in the customer's sweepstakes account for future sweepstakes. The points or sweepstakes entries may have an expiration date, such as 1 year, (i) to ensure that the customer does not build up too many points and (ii) to continue to motivate the customer generate new points by remaining an active customer of the communications service provider.

If the customer has created preferences for the sweepstakes, then the sweepstakes system follows the preferences set by the customer. So, for example, if the customer sets up his or her sweepstakes preferences to submit a maximum number of sweepstakes entries earned prior to a sweepstakes, then the system automatically converts the total number of points available for a sweepstakes into sweepstakes entries.

At step 1006, a determination may be made as to whether the customer has gifted sweepstakes entries to any other customer or non-customer of the communications service provider. If the customer has gifted sweepstakes entries to another individual, then the sweepstakes system applies that gift to the other individual, reduces the number of points or sweepstakes entries available to the customer, and makes available the remaining sweepstakes entries to the customer for submission into a sweepstakes based on preferences or selections of the customer, as previously described. It should be understood that if the customer has gifted all of his or her sweepstakes entries to another individual, that the customer may not be entered into the sweepstakes him or herself as a result of not having any available sweepstakes entries left.

At step 1008, the customer sweepstakes entries and gift sweepstakes entries are submitted into the sweepstakes. At step 1010, the sweepstakes may be performed. The sweepstakes may be performed in a variety of different ways, as understood in the art and as required by state and federal sweepstakes laws. For example, sweepstakes winner(s) may be drawn from all sweepstakes entries of customers and gifted sweepstakes entries, thereby guaranteeing a winner of the sweepstakes.

Before or after the sweepstakes are performed at step 1010, prizes may be selected by the communications service provider. In one embodiment, the prizes may be selected based on a total number of sweepstakes. Alternatively, the sweepstakes prizes may be fixed on a periodic basis (e.g., monthly, quarterly, annually). If the prizes are to be financial (e.g., cash or credit), then the prizes may be based on company performance, cost of service plans, or otherwise. If the prizes are to be tangible, then the prizes may be selected based on sponsorship from sponsorship companies, company performance, number of sweepstakes entries, or otherwise. In addition to the communications service provider selecting prizes, the winner(s) of the sweepstakes may select prize(s) if the sweepstakes allows for selection of a prize from among a number of prizes. As further described herein, the customer may set a preference to select a prize, distribution type (e.g., cash or credit), payout type (e.g., immediate or installments), and so forth.

At step 1012, sweepstakes prize(s) are distributed pursuant to customer preference and gifting settings of customers. As previously described, the customer preferences may provide the sweepstakes system with information for paying and/or crediting a customer for winnings from the sweepstakes if the winnings are financial. If the customer has gifted all or a portion of winnings to another individual, then the winnings are appropriately distributed. In addition to distributing the sweepstakes prize(s), the system may be configured to communicate a notification as to the winnings, such as geographic area in which the winner(s) are located and other information that complies with national and local sweepstakes laws. In one embodiment, the system may make available information of the winner(s) on a website, for example.

With regard to FIG. 11, a flow diagram of an illustrative process 1100 for conducting a sweepstakes. The process 1100 starts at step 1102 what account information including customer service plan data and customer history data of a customer may be stored. In one embodiment, the customer service plan data and customer history data may be stored in on a storage unit and in a data repository, where the data repository may be a database, as understood in the art. At step 1104, the customer account information may be accessed so as to use the customer account information. At step 1106, a total number of points collected by the customer during a time period may be calculated. The calculation may include using the customer account information to determine points or weighting factor and points, as previously described herein. In an alternative embodiment, rather than using points, the process 1100 may issue sweepstakes entries directly without using a points or weighting factor process.

At step 1108, a determination of a number of sweepstakes entries that the customer has achieved based on a calculated total number of points may be made. The determination may be made based on a number of points needed to convert to a sweepstakes entry (e.g., 1000 points per sweepstakes entry). At step 1110, a customer may be entered into a sweepstakes with at least a portion of the achieved sweepstakes entries for the time period. In one embodiment, the number of sweepstakes entries to be entered may be automatically submitted based on a customer's preferences set prior to the sweepstakes. Alternatively, the customer may manually submit the sweepstakes entries into the sweepstakes. If the customer has selected to gift his or her sweepstakes entries to another individual, then the other individual may be submitted into the sweepstakes, as previously described. At step 1112, a sweepstakes drawing may be conducted for the sweepstakes to select one or more winning sweepstakes entries. At step 1114, a prize to a winner of the sweepstakes may be awarded. The prize may have a monetary value (e.g., cash or credit), services value (e.g., downloads or roaming), tangible value (e.g., mobile device or vehicle), or intangible value (e.g., publicity). In one embodiment, notification of the winner may be communicated to the winner, such as the customer, or multiple sweepstakes entrants (e.g., all sweepstakes entrants).

The previous description is of a preferred embodiment for implementing the invention, and the scope of the invention should not necessarily be limited by this description. The scope of the present invention is instead defined by the following claims.

1. A method of reducing churn of customers for a communications service provider, said method comprising:
storing, by a data repository, account information of a customer of the communications service provider, the customer account information including customer service plan data of a customer service plan and customer history data;
accessing, by a computing unit, the customer account information;
calculating, by the computing unit, a total number of points collected by the customer during a time period based on the customer account information, the calculating including totaling points associated with the customer service plan data and customer history data;
determining a number of sweepstakes entries the customer achieved based on the calculated total number of points;
entering the customer into the sweepstakes with at least a portion of the achieved sweepstakes entries for the time period;
conducting a sweepstakes drawing for the sweepstakes; and
awarding a prize to a winner of the sweepstakes.

2. The method according to claim 1, wherein storing account information includes storing customer service plan data that includes identifying one of a plurality of available service plans of which the customer is currently enrolled, and wherein calculating the total number of points includes applying a weighting factor to the customer service plan data.

3. The method according to claim 2, wherein applying a weighting factor includes using a weighting factor that is larger for a customer service plan that uses a frequency spectrum more efficiently than a customer service plan that uses a frequency spectrum less efficiently.

4. The method according to claim 2, wherein applying a weighting factor includes applying a weighting factor that is higher for a multi-line customer service plan.

5. The method according to claim 2, wherein applying a weighting factor includes applying a weighting factor that is at least in part based on a type of handset used by the subscriber during the time period.

6. The method according to claim 2, wherein applying a weighting factor includes applying a weighting factor that is at least in part based on frequency of handset upgrades by the customer.

7. The method according to claim 2, wherein applying a weighting factor includes applying a weighting factor that is at least in part based on frequency of service calls made by the customer.

8. The method according to claim 2, wherein applying a weighting factor includes applying a weighting factor that is at least in part based on whether the customer has opted in or out of one or more marketing programs.

9. The method according to claim 2, wherein applying a weighting factor includes applying a weighting factor that is at least in part based on an amount of roaming that the customer utilized during the time period.

10. The method according to claim 2, wherein applying a weighting factor includes applying a weighting factor that is at least in part based on an amount of costs utilized to service the customer during the time period.

11. The method according to claim 1, further comprising:
allowing a customer to preselect winnings from the sweepstakes to be credited to future communications services; and
in response to the customer winning the sweepstakes, crediting the customer's account with at least a portion of the winnings of the sweepstakes if the customer preselected to have winnings credited.

12. The method according to claim 11, wherein crediting the customer's account includes limiting a maximum amount that can be credited to the customer's account.

13. The method according to claim 1, further comprising:
enabling the customer to gift winnings from the sweepstakes with an existing customer or a non-customer of the communications service provider; and
crediting an account balance of the existing customer or non-customer as directed by the customer.

14. The method according to claim 1, further comprising:
enabling the customer to gift sweepstakes entries to another customer or non-customer.

15. The method according to claim 1, further comprising:
allowing the customer to select a number of sweepstakes entries to enter into, the sweepstakes for the time period; and
storing a total number of available sweepstakes entries not submitted into the sweepstakes to allow the customer to enter the sweepstakes entries in future sweepstakes.

16. The method according to claim 15, further comprising setting an expiration date for the stored total number of available sweepstakes entries.

17. The method according to claim 1, further comprising:
storing, by the data repository, address information of the customer;
in response to the customer winning the sweepstakes, comparing the stored address information with address information collected from the customer when claiming the sweepstakes;
determining whether the stored address information matches the address information collected from the customer when claiming the sweepstakes; and
if the determination does not result in a match, not awarding a prize from the sweepstakes to the customer,
otherwise, if the determination does result in a match, awarding the prize from the sweepstakes to the customer.

18. The method according to claim 1, wherein storing the customer history data includes storing information indicative of customer in-network and roaming usage, and wherein totaling points includes determining whether the customer has roaming usage greater than a predetermined percentage of total usage time; and
in response to determining that the customer has a roaming usage greater than the predetermined percentage of total usage time, reducing the total number of points.

19. The method according to claim 1, wherein storing the customer history data includes storing information of previous time periods of the customer being a customer of the communications service provider, and wherein calculating the total number of points includes applying a weighting factor that is at least based on a previous number of time periods of the customer being a customer of the communications service provider.

20. The method according to claim 19, wherein calculating the total number of points includes applying a weighting factor that is at least based on whether the customer has been a customer for a continuous predetermined number of time periods.

21. The method according to claim 20, wherein calculating the total number of points includes applying a weighting factor that is based on at least in part a number of continuous time periods that the customer has not been canceled or suspended.

22. The method according to claim 1, wherein storing the customer history data includes storing referrals of new subscribers during the time period by the customer, and wherein calculating the total number of points includes applying a weighting factor to a number of referrals during the time period to adjust the weighting factor.

23. The method according to claim 1, wherein storing the customer history data includes storing information indicative of the customer being placed on a pre-suspended list, and wherein calculating the total number of points includes applying a weighting factor indicative of the customer not being placed on the pre-suspended list.

24. The method according to claim 1, wherein storing the customer history data includes storing information indicative of the customer upgrading a mobile device during the time period, and wherein calculating the total number of points includes applying a weighting factor indicative of the customer upgrading the mobile device.

25. The method according to claim 1, wherein awarding the prize includes awarding cash to the customer.

26. The method according to claim 1, wherein awarding the prize includes awarding monthly service credits for using the communications services provided by the communications service provider.

27. The method according to claim 1, wherein awarding the prize includes awarding downloads using the communications services from the communications service provider.

28. The method according to claim 1, wherein awarding the prize includes awarding roaming minutes by the communications service provider.

29. The method according to claim 1, wherein the customer service plan is a customer service plan for flat-rate communications services.

30. The method according to claim 29, wherein the customer service plan is further a customer service for prepaid communications services.

31. The method according to claim 30, wherein storing the customer history data includes storing usage of the services provided by the customer service plan data, thereby incentivizing the customer to maintain a current level of services usage.

32. The method according to claim 30, wherein calculating a total number of points includes calculating the total number of points at least in part as a function of the usage of the services provided by the customer service plan data

33. The method according to claim 30, wherein calculating the total number of points includes applying a weighting factor that has an inverse relationship with the usage, whereby less usage of the services is provided with a weighting factor that results in more points.

34. The method according to claim 30, wherein storing the customer history data includes storing usage of the services provided by the customer service plan data, thereby incentivizing the customer to decrease a current level of services usage.

35. The method according to claim 30, wherein calculating the total number of points includes applying a weighting factor that has an inverse relationship with network resources offered by a service plan, whereby fewer network resources offered by a service plan as included in the customer service plan data results in more points.
